(19) United States
(12) Patent Application Publication
(10) Pub. No.: US 2009/0238321 A1
(43) Pub. Date: Sep. 24, 2009

(54) Nuclear power plant with actinide burner reactor

(75) Inventors: William Casino, JR., Lynchburg, VA (US); James W. Maddox, Lynchburg, VA (US)

Correspondence Address: Davidson, Davidson & Kappel, LLC, 485 7th Avenue, 14th Floor, New York, NY, 10018, US

(73) Assignee: AREVA NP Inc., Lynchburg, VA (US)

(21) Appl. No.: 12/077,630

(22) Filed: Mar. 20, 2008

(51) Int. Cl. G21C 11/00

(52) U.S. Cl. 376/293

(57) ABSTRACT

A nuclear reactor includes a coolant and a core. The core includes a moderator material and a plurality of fuel assemblies arranged within the moderator material, each fuel assembly including an inner region and an outer region surrounding the inner region. The inner region includes at least one first fuel structure containing at least one byproduct actinide, and the outer region includes a plurality of second fuel structures containing thermal spectrum driver fuel, the second fuel structures being less than one thermal neutron mean free path apart. Other embodiments are also provided, as is a nuclear power plant and a fuel assembly.

### BACKGROUND

The present invention relates generally to nuclear power plants, and more specifically to a nuclear power plant capable of processing actinides produced as byproducts from uranium based nuclear reactors.

U.S. Publication No. 2004/0022342 A1 discloses a method of incineration of minor actinides in nuclear reactors. The minor actinides to be incinerated, are embedded in at least one finite region of a core of a thermal reactor, wherein the finite region is isolated from the rest of the core by means of a barrier layer that absorbs thermal neutrons but is transparent to fast neutrons. This publication requires a common barrier layer of fissible material that isolates the finite “fast island” from the rest of a core. The publication discloses that the thermal reactor may be a pressurized water reactor, or a high-temperature-gas-cooled reactor. U.S. Publication No. 2004/0022342 A1 is hereby incorporated by reference herein.

“A Liquid-Metal Reactor for Burning Minor Actinides of Spent Light Water Reactor Fuel—I: Neutronics Design Study” by Hangbok Choi and Thomas J. Downar discloses a decoupled core with two zones: a minor actinide zone and a plutonium-enriched zone. The minor actinide zone was used to burn the minor actinides effectively using a hard spectrum, while the plutonium zone was introduced to compensate for the deteriorating safety performance due to heavy minor actinide loading.

Advanced gas-cooled reactors (hereinafter AGRs) typically use uranium as the fuel, graphite as the neutron moderator and carbon dioxide as coolant. Several Generation III reactors are also in development, including sodium-cooled fast reactors, gas-cooled fast reactors, lead-cooled fast reactors and molten salt reactors. These are typically envisioned as fast reactors.

Byproduct actinides are transuranic byproducts created from the use of the U235 thermal spectrum fuel cycle in currently deployed light water reactors (LWRs), and include americium 241 and neptunium 237.

### SUMMARY OF THE INVENTION

In accordance with an embodiment of the present invention, a thermal nuclear reactor includes a coolant and a core. The core includes a moderator material and a plurality of fuel assemblies arranged within the moderator material. Each fuel assembly includes an inner region and an outer region surrounding the inner region. The inner region includes at least one first fuel structure containing at least one byproduct actinide, and the outer region includes a plurality of second fuel structures containing thermal spectrum driver fuel, the second fuel structures being less than one thermal neutron mean free path apart.

By having the plurality of second fuel structures at less than one thermal neutron mean free path apart, the second fuel structures can shield the inner region from thermal neutrons and thereby suppress the thermal neutron flux density in the inner region. The resultant high fast neutron density in the inner region can aid in burning the byproduct actinides in the first fuel structure, while the plurality of second fuel structures permits easy provision of the thermal driver fuel, for example in the form of fuel rods containing uranium.

In accordance with a second embodiment of the present invention, a thermal nuclear reactor includes a coolant including a molten salt or metal, and a core. The core includes a moderator material and a plurality of fuel assemblies arranged within the moderator material. Each fuel assembly includes an inner region and an outer region surrounding the inner region. The inner region includes at least one first fuel structure containing at least one byproduct actinide, and the outer region includes at least one second fuel structure containing thermal spectrum driver fuel shielding the first fuel structure from thermal neutrons.

By using a molten salt or metal, which have high thermal performance, as the coolant, the second thermal spectrum driver fuel can provide good thermal neutron shielding. For example, the at least one second fuel structure may include a plurality of fuel structures less than one thermal neutron mean free path apart, or be fashioned as a single plate or cylinder surrounding the inner region. By using the molten salt or metal, the core can operate at a high power density with a plurality of the fuel assemblies while retaining the advantageous safety properties of a thermal reactor.

According to a third embodiment of the present invention, a thermal nuclear reactor includes a coolant and a core. The core includes a moderator material and a plurality of fuel assemblies arranged within the moderator material, and separated solely from each other by the moderator material. Each fuel assembly includes an inner region and an outer region surrounding the inner region. The inner region includes at least one first fuel structure containing at least one byproduct actinide, and the outer region includes at least one second fuel structure containing thermal spectrum driver fuel shielding the first fuel structure from thermal neutrons.

By having the plurality of fuel assemblies located next to each other and separated solely by the moderator material, a new type of reactor can be created which permits substantial burning of byproduct actinides in the inner regions while still operating with the safety characteristics of a thermal nuclear reactor. Preferably, at least nine of the fuel assemblies are provided.

A nuclear power plant having a reactor of the types described above is also provided, and may include a heat exchange system removing heat from the coolant to power a generator.

The present invention also provides a fuel assembly including an inner region and an outer region surrounding the inner region. The inner region includes at least one first fuel structures containing at least one byproduct actinide, and the outer region includes a plurality of second fuel structures containing thermal spectrum driver fuel, the second fuel structures being less than one thermal neutron mean free path apart.

### BRIEF DESCRIPTION OF THE DRAWINGS

Preferred embodiments of the present invention will be described with respect to the drawings in which:

FIG. 1 shows schematically a nuclear power plant according to a preferred embodiment of the present invention;

FIG. 2 shows a top view of a core of a nuclear reactor of the nuclear power plant shown in FIG. 1;

FIG. 3 shows a three-dimensional cutaway view of the core shown in FIG. 2;

FIG. 4 shows a portion of a fuel assembly in the core shown in FIG. 2;

FIG. 5 shows a three-dimensional cutaway view of the fuel assembly shown in FIG. 4;

FIG. 6 shows a Table 1: Various Coolants and their Properties Relative to Graphite; and

FIG. 7 shows another preferred embodiment of a fuel assembly according to the present invention.

### DETAILED DESCRIPTION OF THE PREFERRED EMBODIMENTS

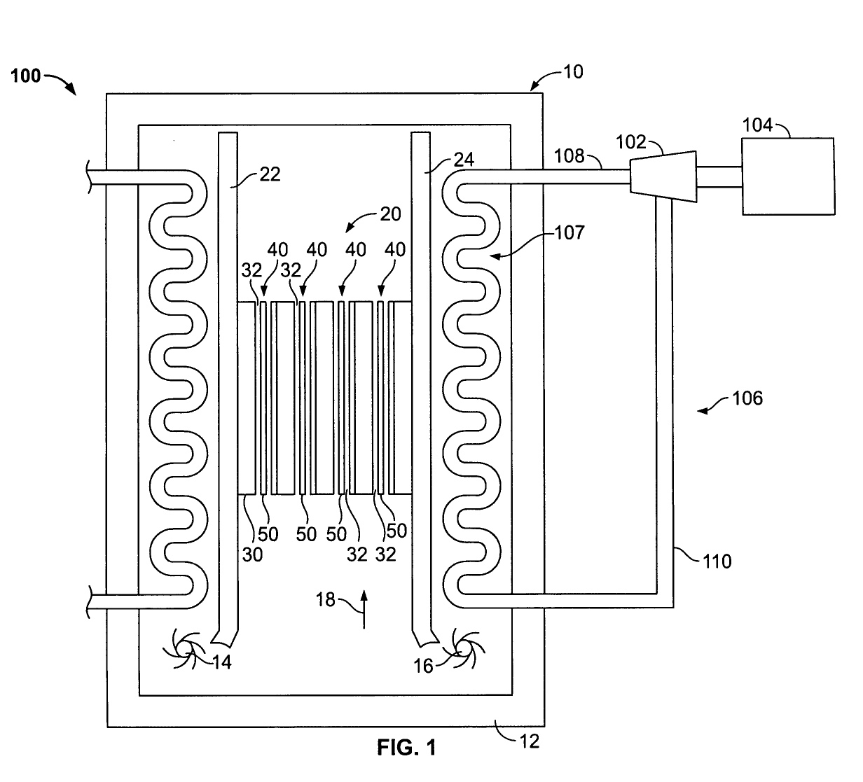

FIG. 1 shows schematically a nuclear power plant 100 according to one embodiment of the present invention. Nuclear power plant 100 includes a thermal nuclear reactor 10, a heat exchange system 106, a turbine 102 and a generator 104. Heat exchange system 106 includes a hot leg 108 and a cold leg 110. Hot leg 108 is downstream of reactor 10 and upstream of turbine 102. Cold leg 110 is downstream of turbine 102 but upstream of reactor 10. In hot leg 108, steam travels from nuclear reactor 10 to turbine 102. In cold leg 110, water travels from turbine 102 to nuclear reactor 10.

Nuclear reactor 10 includes a containment wall 12, a core 20, circulators 14, 16, supports 22, 24 and coolant 18. Coolant 18 preferably is a high thermal performance coolant such as a liquid salt or metal. Heat is transferred from coolant 18 to heat exchange system 106 at a heat area 107 to turn water in cool leg 110 into steam. Circulators 14, 16 move coolant 18 through core 20.

Core 20 includes a moderator 30 and a plurality of fuel assemblies 40 located in a plurality of coolant channels 32 in moderator 30. Each fuel assembly 40 is placed inside a coolant channel 32 in moderator 30. Moderator 30 may be, for example, graphite, for example, in single block form or several pieces fitted together, for example, hollow hexagonals of graphite material. Coolant 18 is circulated through core 20 and moves through coolant channels 32 past fuel assemblies 40.

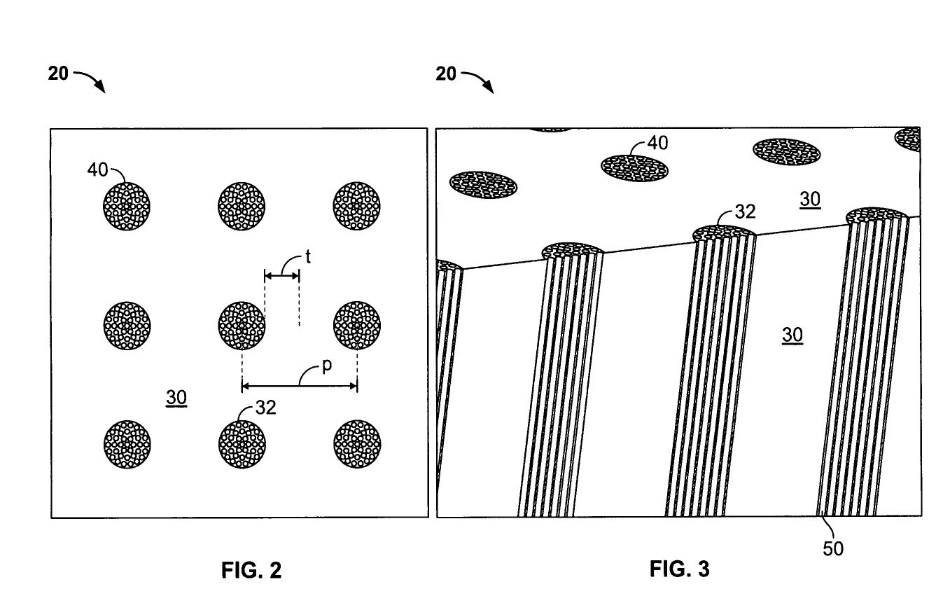

FIGS. 2 and 3 show fuel assemblies 40 arranged in channels 32 of core 20 in a square lattice arrangement. Each fuel assembly 40 is spaced apart by a fuel assembly pitch, p. The moderator thickness, t, is also shown. FIG. 3 shows a three dimensional cutaway view of core 20. Each fuel assembly 40 includes a plurality of fuel structures 50, which may be, for example, a plurality of rods supported at one end for insertion into coolant channel 32.

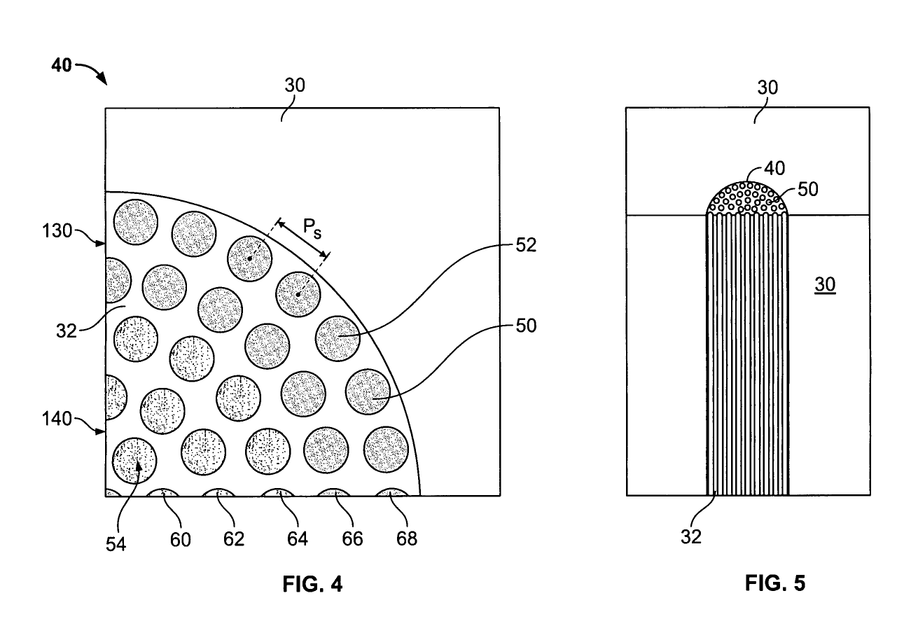

FIGS. 4 and 5 show a portion of a fuel assembly 40 surrounded by moderator 30. Fuel assembly 40 includes a thermal driver fuel region 130 and a fast target fuel region 140. Coolant channel 32 is cut, for example, in a block of moderator 30. The moderator may be, for example, graphite. Thermal driver fuel region 130 and fast target fuel region 140 may be configured as a series of concentric annuli 60, 62, 64, 66, 68 of fuel containing structures 50 placed in coolant channel 32. Fuel containing structures 50 may be, for example, pins, cylinders, plates or other fuel containing devices.

In FIG. 4, thermal driver fuel region 130 includes outermost concentric annuli 66, 68 and fast target fuel region 140 includes innermost concentric annuli 60, 62, 64. Annuli 66, 68 include fuel structures 50 containing thermal spectrum driver fuel 52, for example, pelletized 5 w/o UO₂. Annuli 60, 62, 64 include target fuel 54, for example, byproduct actinide oxide pellets, a canister of molten target fuel, or another arrangement that places target material within the central portion of fuel assembly 40 may be used. Target material may include, for example, americum 241 and neptunium 237. Fuel structures 50 in annuli 60, 62, 64, 66, 68 are arranged in a way so the fuel content of each fuel structure 50 in each annulus 60, 62, 64, 66, 68 may be varied so that the thermal driver fuel region 130 surrounds the fast target fuel region 140.

Fuel structures 50 in thermal driver fuel region 130 are in very close proximity to each other. The pitch pₛ of fuel structures 50 is shown in FIG. 4. The pitch pₛ is less than one thermal neutron mean free path so fuel structures 50 are less than one thermal neutron mean free path apart. Annuli 60, 62, 64 are located several mean free paths into assembly 40. Thus, thermal neutrons entering fuel assembly 40 from moderator 30 are absorbed into thermal driver fuel region 130 by annuli 66, 68 and do not reach annuli 60, 62, 64 of fast target fuel region 140. This regional self-shielding effect causes the thermal neutron flux density to decrease significantly within a couple of mean free paths into fuel assembly 40 from moderator 30. This shielding effect provides a neutron flux spectral shift within fuel assembly 40. The inner region, fast target fuel region 140, is dominated by high fast neutron flux density while the thermal neutron flux density is depressed. The outermost annuli 66, 68 in thermal driver fuel region 130 are well utilized due to their close proximity to moderator 30. The neutron spectral shift phenomenon allows reactor 10 to transmutate the byproduct actinides in the fast target fuel region 140.

The behavior of core 20 in reactor 10 can be driven by thermal driver fuel region 130, thus providing the safer control and transient behavior characteristics of a thermal spectrum critical reactor system, as opposed to those of third generation fast reactors. The fuel assembly pitch p and the moderator thickness t can be selected so the temperature coefficient remains safely negative, even though a plurality of fuel assemblies can be located next to each other and separated solely by the moderator material. At the same time, byproduct actinides can be burned. The arrangement of fuel structures 50 into thermal driver fuel region 130 and fast target fuel region 140 allows for optimal transuranic burning capabilities of minor actinides in region 140 while maintaining the safety and controllability characteristics associated with thermal neutrons in region 130.

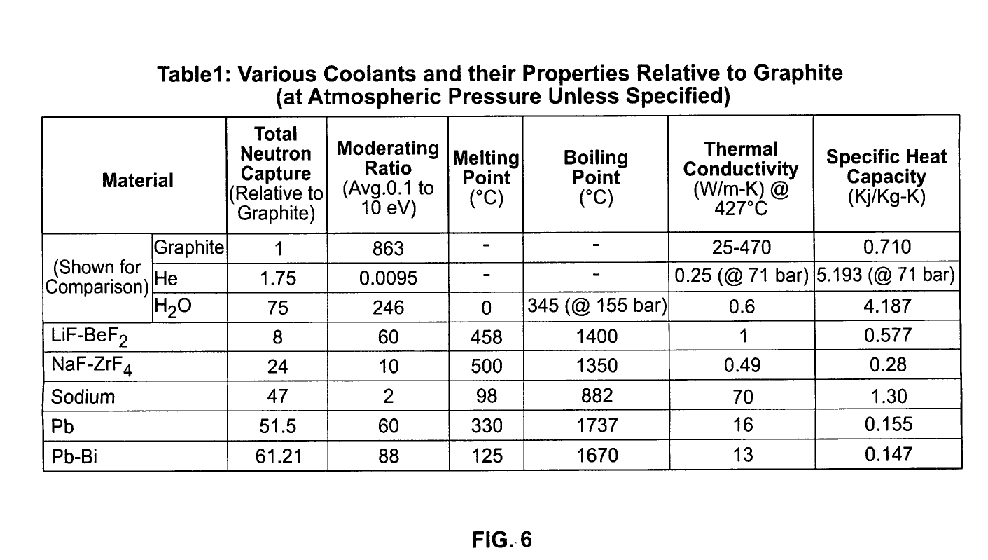

Because the outer annuli of fuel structures in the FIG. 1 embodiment must be within close proximity to each other in order to amplify self shielding, a high thermal performance coolant is needed or low power densities need to be employed. It is generally not preferred to use low power densities because they are not as cost efficient or effective. If coolant 18 has above average heat transfer and energy storage thermo-physical properties, localized hot spots and temperature peaks in thermal driver fuel region 130 advantageously can be minimized. Also, coolant 18 preferably has relatively low thermal absorption and scatter cross-sections. A high-performance coolant 18 also can allow high power density fuel assemblies to be engineered with pitch values comparable to one mean free path or less and coolant 18 also can have a relatively low impact on the neutron energy spectrum of the system. FIG. 6 shows preferred coolants that may be considered for use in reactor 10 and the relevant thermal and nuclear property data. The coolant preferably is a molten salt or liquid such as, for example, molten lithium fluoride-beryllium fluoride, sodium fluoride-zirconium fluoride, sodium, lead, or lead-bismuth.

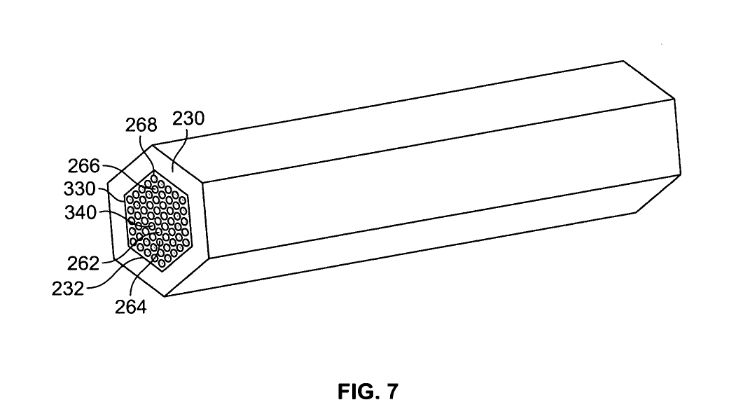

Neither coolant channel 32 nor annuli 60, 62, 64, 66, 68 need be cylindrical, for example, prismatic or other geometric shapes may be used, as long as the fuel is zoned radially from the center of fuel assembly 40 towards an outer peripheral region where moderator 30 is located. FIG. 7 shows an alternative geometric configuration, where moderator 230 and coolant channel 232 are hexagonal. Annuli 268, 266, 264, 262 including fuel structures 250 are arranged in concentric hexagons in coolant channel 232. Thermal driver region 330 includes annuli 268 and 266, while fast target region 240 includes annuli 262 and 264. Thus, thermal neutrons entering fuel assembly 240 from moderator 230 are absorbed into thermal driver fuel region 330 by annuli 266, 268 and do not reach annuli 260, 262, 264 of fast target fuel region 340. The moderator hexagonals can then be placed against each other to provide the core modulator structure.

In addition, having the outer region of the fuel assembly be separate structures less than one thermal neutron mean free path apart is advantageous as it permits easier manufacture of the fuel assembly and safer characteristics, it is also possible to fashion the outer region as a single plate or cylinder of thermal spectrum driver fuel surrounding the inner region.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

1: A nuclear reactor comprising:
a coolant; and
a core, the core including a moderator material and a plurality of fuel assemblies arranged within the moderator material, each fuel assembly including:
an inner region and an outer region surrounding the inner region, the inner region including at least one first fuel structure containing at least one byproduct actinide, and the outer region including a plurality of second fuel structures containing thermal spectrum driver fuel, the second fuel structures being less than one thermal neutron mean free path apart.

2: The nuclear reactor as recited in claim 1 wherein the second fuel structures are fuel rods.

3: The nuclear reactor as recited in claim 1 wherein the moderator material is graphite.

4: The nuclear reactor as recited in claim 1 wherein the byproduct actinides include americium 241 or neptunium 237.

5: The nuclear reactor as recited in claim 1 wherein the thermal spectrum driver fuel is uranium.

6: The nuclear reactor as recited in claim 5 wherein the thermal spectrum driver fuel is pelletized UO₂.

7: The nuclear reactor as recited in claim 1 wherein the coolant is a molten salt or metal.

8: The nuclear reactor as recited in claim 7 wherein the coolant includes at least one of the following: lithium fluoride-beryllium fluoride, molten sodium fluoride-zirconium fluoride, sodium, lead, and lead-bismuth.

9: The nuclear reactor as recited in claim 1 wherein the at least one first fuel structure includes a plurality of first fuel structures.

10: A nuclear power plant comprising the nuclear reactor as recited in claim 1, a heat transfer system removing heat from the coolant, and a generator powered by the heat transfer system.

11: A nuclear reactor comprising:
a coolant including a molten salt or metal; and
a core, the core including a moderator material and a plurality of fuel assemblies arranged within the moderator material, each fuel assembly including:
an inner region and an outer region surrounding the inner region, the inner region includes at least one first fuel structure containing at least one byproduct actinide, and the outer region includes at least one second fuel structure containing thermal spectrum driver fuel shielding the first fuel structure from thermal neutrons.

12: A nuclear reactor comprising:
a coolant; and
a core, the core including a moderator material and a plurality of fuel assemblies arranged within the moderator material, the plurality of fuel assemblies being separated solely from each other by the moderator material, each fuel assembly including:
an inner region and an outer region surrounding the inner region, the inner region including at least one first fuel structure containing at least one byproduct actinide, and the outer region includes at least one second fuel structure containing thermal spectrum driver fuel shielding the first fuel structure from thermal neutrons.

13: A nuclear fuel assembly comprising:
an inner region and an outer region surrounding the inner region, the inner region including at least one first fuel structure containing at least one byproduct actinide, and the outer region including a plurality of second fuel structures containing thermal spectrum driver fuel, the second fuel structures being less than one thermal neutron mean free path apart.
